(19) United States
(12) Patent Application Publication
(10) Pub. No.: US 2018/0044616 A1
(43) Pub. Date: Feb. 15, 2018

(54) FRAGRANCED PASTILLE FOR LAUNDRY APPLICATION

(71) Applicant: Henkel IP & Holding GmbH, Duesseldorf (DE)

(72) Inventor: Dan Piorkowski, Fairfield, CT (US)

(73) Assignee: Henkel IP & Holding GmbH, Duesseldorf (DE)

(21) Appl. No.: 15/661,081

(22) Filed: Jul. 27, 2017

Related U.S. Application Data
(60) Provisional application No. 62/370,389, filed on Aug. 3, 2016.

(51) Int. Cl. C11D 17/00; C11D 11/00; C11D 3/50

(52) U.S. Cl. CPC C11D 17/0047; C11D 3/50; C11D 3/505; C11D 11/0017

(57) ABSTRACT

Provided herein are solid compositions for fabric treatment; aerated solid compositions for fabric treatment; unit dose laundry detergent compositions containing solid compositions or aerated solid compositions for fabric treatment; and methods of their making and using, e.g., for treating textiles.

### CROSS-REFERENCE TO RELATED APPLICATIONS

The present application claims priority to U.S. Provisional Application 62/370,389 filed Aug. 3, 2016 and entitled “FRAGRANCED PASTILLE FOR LAUNDRY APPLICATION”, which is incorporated herein.

### BACKGROUND OF THE INVENTION

### Field of the Invention

This application relates to fragranced solid compositions for laundry application, as well as their use and manufacture. The application also relates to laundry detergent compositions employing fragranced solid compositions, and their use and manufacture.

### Description of the Related Art

Textiles can have an undesirable smell after washing, and thus are often treated with detergent and/or fabric softener, or by additional treatments and processes that are separate from their washing. The treatments are separate because the compositions used are often not compatible with the washing detergent. These additional processes can be done, for example, in the washer during an added rinse cycle, or in the dryer. However, separate treatments and using increased amounts of detergent and/or fabric softener have drawbacks. For example, an additional rinse cycle will use extra water and electricity to power the washer, which can be detrimental to the environment. Also, some separate treatments employ solid compositions that may not completely solubilize during a wash cycle or a rinse cycle. Such solid compositions can also be brittle and difficult to handle and manufacture.

U.S. Pat. No. 7,867,968 relates to scent additives for textiles which comprise polyethylene glycol (“PEG”) and one or more perfumes. The compositions are shaped into a pastille and contain a free and/or an encapsulated perfume, and optionally colorants (such as dyes).

U.S. Pat. No. 7,871,976 discloses laundry scent additives for textiles which comprise PEG and one or more perfumes. The compositions can be shaped into a pastille and contain only encapsulated perfume, and optionally colorants (such as dyes).

United States Patent Application Publication No. 2013/0095717 relates to solid and liquid textile treating compositions comprising a water-soluble core that contains a water-soluble carrier; a coating that at least partially covers the water-soluble core and contains a water-soluble polymer, a colorant, a colorant stabilizer and optionally a perfume; and a flow aid that is incorporated at least partly into the coating. The solid and liquid textile treating compositions can be included in washing or cleaning products.

United States Patent Application Publication No. 2016/0160157 relates to a solid wash cycle conditioning agent comprising a non-ionic surfactant (e.g., block copolymers and sorbitan esters) and a fabric conditioning agent. The solid wash cycle conditioning agent can further contain a plasticizer (e.g., polyethylene glycol stearates and glyceryl stearate), a colorant, a colorant stabilizer, and a perfume.

There remains a need for solid compositions to effectively deliver fragrance to textiles that are not brittle and can completely solubilize in the presence of a detergent during a wash cycle.

### SUMMARY OF THE INVENTION

The compositions, containers containing the compositions, and methods provided in present disclosure are exemplary and are not intended to limit the scope of the claimed embodiments.

One aspect of the present disclosure is a solid composition for fabric treatment that comprises one or more block copolymers (e.g., copolymers of Formula (I) through (IV) described herein), a glycol fatty acid ester (e.g., ethylene glycol monostearate) and a fragrance. It has been discovered that block copolymers can result in brittle solid compositions with low melting points, uneven surface roughness, and poor shape. It has also been discovered that solid glycol fatty acid esters can be brittle and that glycerol fatty acid esters can form a plastic-like soap scum during wash cycles. The present inventors surprisingly found that the combination of one or more block copolymers with a glycol fatty acid ester increases the strength and melting point of the solid composition of the present disclosure; increases water solubility of the solid composition; and eliminates/minimizes the formation of plastic-like soap scum. The inventors further surprisingly found that the combination of one or more block copolymers with a glycol fatty acid ester gives the solid composition a good shape and a shiny, pearlescent appearance.

In one embodiment, the one or more block copolymers have Formulae (I) through (IV) or a combination thereof: R¹O-(EO)x-(PO)y-R² (Formula (I)), R¹O—(PO)x-(EO)y-R² (Formula (II)), R¹O-(EO)o-(PO)p-(EO)q-R² (Formula (III)), and R¹O—(PO)o-(EO)p-(PO)q-R² (Formula (IV)).

The solid composition for fabric treatment can be in the form selected from the group comprising a pastille, a granule, a pellet, a powder, a pulverized powder, a tablet, and a crystal.

In a further embodiment is provided a unit dose fabric treatment composition comprising the solid composition for fabric treatment of the present disclosure. The unit dose can further contain sodium chloride, fragrance, or a combination thereof. The unit dose can deliver fragrance to a textile, deliver fabric care to a textile, clean a textile, or combinations thereof. In certain such embodiments, the unit dose is suitable for addition to a washing machine at the beginning of the wash cycle.

In another embodiment is provided a solid composition for fabric treatment that comprises one or more block copolymers, a glycol fatty acid ester, a fragrance, and a colorant. The colorant can be selected from the group consisting of a water-soluble polymer, water-insoluble polymer, a water-soluble dye, a water-insoluble dye, and a combination thereof.

In a further embodiment is provided a solid composition for fabric treatment that comprises one or more block copolymers, a glycol fatty acid ester, a fragrance, and a filler. The filler can be selected from the group consisting of clay and starch material.

In another embodiment is provided a solid composition for fabric treatment that comprises one or more block copolymers, a glycol fatty acid ester, and a fragrance that is substantially free of PEG. In a further embodiment is provided a solid composition for fabric treatment that is substantially free of PEG, and comprises one or more block copolymers, a glycol fatty acid ester, a fragrance, and optionally a colorant, and optionally a filler.

In a further embodiment is provided a laundry detergent composition comprising a detergent and a solid composition for fabric treatment of the present disclosure. The detergent comprises a detersive surfactant.

In another embodiment is provided a unit dose laundry detergent composition comprising a detergent and the solid composition for fabric treatment of the present disclosure. The unit dose laundry detergent composition can further contain sodium chloride, fragrance, or a combination thereof. The unit dose can deliver fragrance to a textile, deliver fabric care to a textile, clean a textile, or combinations thereof. In certain such embodiments, the unit dose laundry detergent composition is suitable for addition to a washing machine at the beginning of the wash cycle.

A further embodiment is a method of perfuming a textile, e.g., delivering a fragrance to a textile, with a solid composition for fabric treatment of the present disclosure.

Another embodiment is a method of delivering fabric care to a textile with a solid composition for fabric treatment of the present disclosure. An additional embodiment is a method of cleaning a textile with a laundry detergent composition.

Another embodiment is a textile perfumed or cleaned by a solid composition for fabric treatment of the present disclosure.

A further embodiment is a method of making a solid composition for fabric treatment comprising mixing and melting a block copolymer, a glycol fatty acid ester, and a fragrance to form a mixture, allowing the mixture to shape, and hardening the shaped mixture. Another embodiment further comprises adding fragrance, and optionally colorant, into the mixture after melting.

An additional embodiment includes a method of making a laundry detergent composition comprising blending a detergent with a solid composition for fabric treatment.

Another aspect of the present disclosure is an aerated, solid composition for fabric treatment that comprises one or more block copolymers (e.g., copolymers of Formula (I) through (IV) described herein), a glycol fatty acid ester (e.g., ethylene glycol monostearate), a fragrance, and a sufficient amount of entrapped air. It has been discovered that many known solid compositions for fabric treatment have poor water solubility. The present inventors surprisingly found that entrapping air, e.g., by aerating, in solid compositions for fabric treatment increases water solubility and results in a higher amount of surface area to provide a faster rate of water solubility as compared with a non-aerated solid composition.

In one embodiment, the one or more block copolymers have Formulae (I) through (IV) or a combination thereof: R¹O-(EO)x-(PO)y-R² (Formula (I)), R¹O—(PO)x-(EO)y-R² (Formula (II)), R¹O-(EO)o-(PO)p-(EO)q-R² (Formula (III)), and R¹O—(PO)o-(EO)p-(PO)q-R² (Formula (IV)).

In a further embodiment is provided an aerated solid composition for fabric treatment comprising PEG, a fragrance, and a sufficient amount of entrapped air.

Another embodiment includes methods of making aerated solid compositions for fabric treatment.

An additional embodiment includes methods of treating textiles with aerated solid compositions for fabric treatment.

A further embodiment includes aerated solid compositions for fabric treatment in the form of unit doses.

### BRIEF DESCRIPTION OF THE FIGURE

FIG. 1 shows a non-aerated, solid composition for fabric treatment (on the left side, labeled “non air-whipped”); and an aerated, solid composition for fabric treatment (on the right, labeled “air-whipped”).

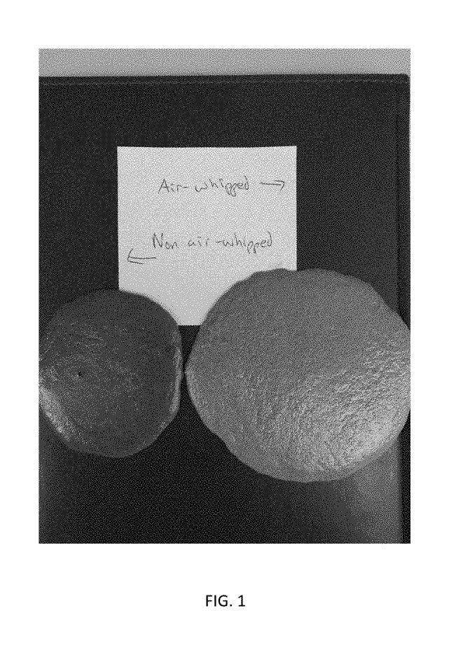

### DETAILED DESCRIPTION OF THE INVENTION

### Definitions

All of the various aspects, embodiments, and options disclosed herein can be combined in any and all variants unless otherwise specified. Terms in this application control in the event of a conflict with a patent or publication term that is incorporated by reference.

As used herein, “a,” “an,” or “the” means one or more unless otherwise specified.

Open terms such as “include,” “including,” “contain,” “containing” and the like mean “comprising.”

The act of treating a textile can refer to, for example, one or more of: i) applying a perfume to a textile; ii) softening a textile; iii) applying a perfume to and softening a textile; iv) cleaning a textile; v) rendering the textile resistant to static build up during drying; or vi) cleaning a textile and applying a perfume to and softening a textile and rendering the textile resistant to static build up during drying; or any combination thereof.

The term “or” can be conjunctive or disjunctive.

Some inventive embodiments contemplate numerical ranges. Every numerical range provided herein includes the range endpoints as individual inventive embodiments. When a numerical range is provided, all individual values and sub-ranges therein are present as if explicitly written out.

The terms “textile” and “fabric” can be used interchangeably.

The terms “fragrance” and “perfume” can be used interchangeably.

The term “substantially free of polyethylene glycol” refers to a composition of the present disclosure that contains little or no polyethylene glycol (“PEG”). A composition of the present disclosure substantially free of PEG may comprise, for example, less than about 5% PEG by weight, or less than about 4% PEG by weight, or less than about 3% PEG by weight, or less than about 2% PEG by weight, or less than about 1% PEG by weight, based on the total weight of the composition.

The term “about” includes the recited number ±10%. For example, “about 10” means 9 to 11.

The term “aerating” denotes entrapping or incorporating air or gaseous material into a composition by any suitable means.

Air or gaseous material is “entrapped” or “incorporated” into a composition by adding air or gaseous material to the composition while the composition is in a liquid, melted, or molten form.

### Solid Compositions for Fabric Treatment (“SCFTs”)

The present disclosure provides a solid composition for fabric treatment. The SCFTs can be used, for example to treat a textile.

The SCFTs of the present disclosure are desirably solid at about 25° C. and soluble in cold, warm, and hot water, and can deliver long lasting fragrance impression.

In one embodiment, the SCFTs solubilize in about 15 minutes or less, or about 14 minutes or less, or about 13 minutes or less, or about 12 minutes or less, or about 11 minutes or less, or about 10 minutes or less, or about 9 minutes or less, or about 8 minutes or less, as measured by a stir-bar method at 59 □F in 120 ppm Ca²⁺/Mg²⁺ water, wherein the ratio of Ca²⁺:Mg²⁺ is 3:1.

In one embodiment, the SCFTs solubilize in about 12 minutes or less as measured by a stir-bar method at 59 □F in 120 ppm Ca²⁺/Mg²⁺ water, wherein the ratio of Ca²⁺:Mg²⁺ is 3:1.

The water solubility can be measured by methods known in the art by a person of ordinary skill in the art. The water solubility can be measured, for example, by stir-bar method at 59 □F in 120 ppm Ca²⁺/Mg²⁺ water, wherein the ratio of Ca²⁺:Mg²⁺ is about 3:1.

In another embodiment is provided a SCFT having a strength ranging from about 5 Newtons to about 50 Newtons, about 7 Newtons to about 35 Newtons, or about 9 Newtons to about 35 Newtons of required force to break the solid composition.

In one embodiment, the SCFT has a strength of at least about 10 Newtons of required force to break the solid composition.

In a further embodiment is provided a SCFT having a melting point ranging from about 32 □C to about 80 □C, about 40 □C to about 70 □C, about 42 □C to about 65 □C, or about 43 □C to about 61 □C.

In one embodiment, the SCFT comprises a block copolymer, a glycol fatty acid ester, and a fragrance. The block copolymer has the Formulae (I) through (IV), or a combination thereof: R¹O-(EO)x-(PO)y-R² (Formula (I)), R¹O—(PO)x-(EO)y-R² (Formula (II)), R¹O-(EO)o-(PO)p-(EO)q-R² (Formula (III)), and R¹O—(PO)o-(EO)p-(PO)q-R² (Formula (IV)). In some embodiments, the SCFT optionally comprises a colorant and/or a filler (e.g., a clay). The SCFT can further include other additives commonly included in a fabric treatment composition.

In one embodiment, the SCFT comprises a ratio of block copolymer(s) to filler to glycol fatty acid ester(s) of about 82:12:5. In another embodiment, the SCFT comprises a ratio of block copolymer(s) to Bentonite clay to ethylene glycol monostearate of about 82:12:5.

In one embodiment, the SCFT is substantially free of PEG. In one embodiment, the SCFT does not contain PEG.

The ingredients in the SCFT can be homogeneously or heterogeneously mixed. In some embodiments, the ingredients in the SCFT are homogeneously mixed.

### Block Copolymer(s)

The block copolymer of the present disclosure can be a block copolymer of Formula (I) through (IV):

R¹O-(EO)x-(PO)y-R² Formula (I),

R¹O—(PO)x-(EO)y-R² Formula (II),

R¹O-(EO)o-(PO)p-(EO)q-R² Formula (III),

R¹O—(PO)o-(EO)p-(PO)q-R² Formula (IV),

or a combination thereof,
wherein EO is a —CH₂CH₂O— group, and PO is a —CH(CH₃)CH₂O— group;
R¹ and R² can independently be H or a C₁-C₂₂ alkyl group,
x, y, o, p, and q can independently be 1-100, and
provided that the sum of x and y is greater than 35, and the sum of o, p, and q is greater than 35.

In one embodiment, the block copolymer has Formula (I) or (II), or a combination thereof, and wherein the ratio of x:y ranges from 1.5:1 to about 10:1, about 2:1 to about 10:1, about 2:1 to about 8:1, about 3:1 to about 8:1, about 3:1 to about 5:1; about 4:1 to about 6:1, or about 4:1, about 3:1, or about 2:1.

In one embodiment, the block copolymer has Formula (III) or (IV), or a combination thereof, and wherein the ratio of (o+q):p ranges from about 1.5:1 to about 10:1, about 2:1 to about 10:1, about 2:1 to about 8:1, about 3:1 to about 8:1, about 3:1 to about 5:1; about 4:1 to about 6:1, or about 4:1, about 3:1, or about 2:1.

A combination of block copolymers includes two or more block copolymers having different Formulae (I), (II), (III), or (IV), or two or more block copolymers having the same Formulae (I), (II), (III), or (IV).

In one embodiment, R¹ and R² are independently H. In one embodiment R¹ and R² are independently a C₁-C₂₂ alkyl group, a C₁-C₁₂ alkyl group, a C₁-C₈ alkyl group, or a C₁-C₄ alkyl group.

The block copolymer(s) can have, individually, a hydrophilic-lipophilic-balance value (HLB), for example, ranging from about 15 to about 35.

The HLB can be calculated, for example, using the methodology of Griffin or Davies (Griffin, W. C., “Classification of Surface-Active Agents by ‘HLB’,” J. Soc. Cosmetic Chemists 1:311 (1949); Davies, J. T., “A Quantitative Kinetic Theory of Emulsion Type, I. Physical Chemistry of the Emulsifying Agent,” Gas/Liquid and Liquid/Liquid Interface, Proceedings the International Congress of Surface Activity 426-438 (1957). Davies' methodology is useful for calculating higher HLB values. Alternatively, McCutcheon's Emulsifiers and Detergents provide HLB values for commercially available nonionic surfactants.

The block copolymer(s) can have, for example, individually, an HLB ranging from about 15 to about 35, from about 17 to about 35, from about 19 to about 35, from about 21 to about 35, from about 23 to about 35, from about 24 to about 35, from about 25 to about 35, from about 26 to about 35, from about 27 to about 35, from about 29 to about 35, from about 31 to about 35, from about 35 to about 15, from about 33 to about 15, from about 31 to about 15, from about 29 to about 15, from about 27 to about 15, from about 25 to about 15, from about 23 to about 15, from about 21 to about 15, from about 17 to about 33, from about 18 to about 32, from about 19 to about 31, from about 20 to about 30, from about 21 to about 29, from about 22 to about 28, or from about 23 to about 27.

The block copolymer(s) can have, for example, individually, an HLB of at least 15, at least 17, at least 20, at least 22, at least 24, at least 25, at least 26, at least 28, at least 30, at least 32, or at least 35. The block copolymer(s) can have, for example, individually, an HLB about 20, 21, 22, 23, 24 or 25.

The block copolymer(s) can have, individually, a weight average molecular weight (g/mol) ranging, for example, from about 3,000 to about 12,000. The weight average molecular weight can range, for example, from about 3,500 to about 12,000, from about 4,000 to about 12,000, from about 4,500 to about 12,000, from about 5,000 to about 12,000, from about 5,500 to about 12,000, from about 6,000 to about 12,000, from about 6,500 to about 12,000, from about 7,000 to about 12,000, from about 7,500 to about 12,000, from about 8,000 to about 12,000, from about 8,500 to about 12,000, from about 9,000 to about 12,000, from about 9,500 to about 12,000, from about 10,000 to about 12,000, from about 10,500 to about 12,000, from about 11,000 to about 12,000, from about 11,500 to about 12,000, from about 11,500 to about 3,000, from about 11,000 to about 3,000, from about 10,500 to about 3,000, from about 10,000 to about 3,000, from about 9,500 to about 3,000, from about 9,000 to about 3,000, from about 8,500 to about 3,000, from about 8,000 to about 3,000, from about 7,500 to about 3,000, from about 7,000 to about 3,000, from about 6,500 to about 3,000, from about 6,000 to about 3,000, from about 5,500 to about 3,000, from about 5,000 to about 3,000, from about 4,500 to about 3,000, from about 4,000 to about 3,000, from about 3,500 to about 3,000, from about 3,200 to about 11,400, from about 3,500 to about 11,000, from about 4,000 to about 10,500, from about 4,000 to about 9,500, from about 4,500 to about 9,500, from about 4,700 to about 8,400, or from about 5,500 to about 7,000.

The block copolymer(s) can comprise a mixture of at least two block copolymers of Formula (I), or at least two block copolymers of Formula (II), or at least two block copolymers of Formula (III), or at least two block copolymers of Formula (IV).

The block copolymer(s) can comprise a mixture of at least one block copolymer of Formula (I) and at least one block copolymer of Formula (II), or at least one block copolymer of Formula (I) and at least one block copolymer of Formula (III), or at least one block copolymer of Formula (I) and at least one block copolymer of Formula (IV), or at least one block copolymer of Formula (II) and at least one block copolymer of Formula (III), or at least one block copolymer of Formula (II) and at least one block copolymer of Formula (IV), or at least one block copolymer of Formula (III) and at least one block copolymer of Formula (IV).

The block copolymer(s) can comprise a mixture of two or more block copolymers having the same formula or different formulae, wherein one block copolymer has a weight average molecular weight (g/mol) ranging from about 3,000 to about 7,500, or from about 3,000 to about 6,000, or from about 4,000 to about 5,000, and another block copolymer has a weight average molecular weight (g/mol) ranging from about 6,000 to about 11,000, or from about 7,000 to about 10,000, or from about 8,000 to about 9,000. In one embodiment, the block copolymers can comprise a mixture of two or more block copolymers having the same formula or different formulae, wherein one block copolymer has a weight average molecular weight (g/mol) ranging from about 4,000 to about 5,000, and another block copolymer has a weight average molecular weight (g/mol) ranging from about 8,000 to about 9,000.

In one embodiment, the block copolymer(s) can comprise a mixture of two or more block copolymers wherein the two or more block copolymers each have a weight average molecular weight ranging from about 3,000 to about 10,000, or from about 4,000 to about 9000.

In one embodiment, the block copolymer comprises a mixture of at least two block copolymers of Formula (III), wherein one block copolymer has a molecular weight (g/mol) ranging from about 4000 to about 5000, and the other block copolymer has a molecular weight ranging from about 8000 to about 9000. In one preferred embodiment, the two block copolymer each have a molecular weight ranging from about 4000 to about 9000. In one preferred embodiment, the ratio of the block copolymer having a molecular weight ranging from about 4000 to about 5000 to the block copolymer having a molecular weight ranging from about 8000 to about 9000 ranges from about 1:3 to about 1:12, from about 1:5 to about 1:12, or from about 1:7 to about 1:10.

The mixture of two or more block copolymers can comprise two block copolymers having different molecular weight. For example, the mixture of two or more block copolymers can have a ratio of a lower molecular weight block copolymer to a higher molecular weight block copolymer ranging from about 1:1 to about 1:15, or about 1:3 to about 1:12, or about 1:5 to about 1:12, or about 1:7 to about 1:10. In one embodiment, the mixture of two or more block copolymers can comprise a ratio of a lower molecular weight block copolymer to a higher molecular weight block copolymer ranging from about 15:1 to about 1:1, or about 12:1 to about 5:1, or about 10:1 to about 7:1.

Exemplary block copolymer(s) include, but are not limited to, PLURONIC®-F38 (BASF), PLURONIC®-F48 (BASF), PLURONIC®-F58 (BASF), PLURONI®C-F68 (BASF), PLURONIC®-F77 (BASF), PLURONIC®-F87 (BASF), PLURONIC®-F88 (BASF), and combinations thereof.

The SCFT can contain the block copolymer(s) in a total amount ranging from about 40% by weight to about 99% by weight, based on the weight of the SCFT. In some embodiments, the SCFT can contain the block copolymer(s) in an amount ranging from about 55% by weight to about 99% by weight, from about 60% by weight to about 99% by weight, from about 65% to about 99% by weight, from about 70% to about 99% by weight, from about 75% by weight to about 99% by weight, from about 80% by weight to about 99% by weight, from about 85% by weight to about 99% by weight, from about 70% by weight to about 95% by weight, from about 75% by weight to about 95% by weight, from about 80% by weight to about 95% by weight, from about 85% by weight to about 95% by weight, from about 70% by weight to about 90% by weight, from about 75% by weight to about 90% by weight, from about 80% by weight to about 90% by weight, or from about 75% by weight to about 85% by weight, based on the weight of the SCFT.

### Glycol Fatty Acid Ester(s)

The glycol fatty acid ester(s) of the present disclosure can comprise a fatty acid portion having a carbon chain length ranging from about 8 carbons to about 25 carbons, from about 8 carbons to about 24 carbons, from about 10 carbons to about 22 carbons, from about 12 carbons to about 20 carbons, or from about 14 carbons to about 18 carbons.

In some embodiments, the glycol fatty acid ester(s) can comprise a fatty acid portion having a saturated carbon chain. In other embodiments, the glycol fatty acid ester(s) can comprise a fatty acid portion having a mono or poly-unsaturated carbon chain.

In some embodiments, the glycol fatty acid ester is a monoester. In other embodiments, the glycol fatty acid ester is a diester.

In some embodiments, the glycol fatty acid ester is a glycol stearate, e.g. a glycol monostearate or a glycol distearate.

In some embodiments, the glycol portion of the glycol fatty acid ester has from about 1 carbon to about 8 carbons, from about 2 carbons to about 5 carbons, or from about 2 carbons to about 4 carbons. In other embodiments, the glycol portion of the glycol fatty acid ester is an ethylene glycol. In further embodiments, the glycol portion of the glycol fatty acid ester is an ethylene glycol or a propylene glycol.

In one preferred embodiment, the glycol fatty acid ester is ethylene glycol monostearate.

In some embodiments, the SCFT can contain, for example, a total amount of glycol fatty acid ester ranging from about 0.05% by weight to about 25% by weight, from about 0.05% by weight to about 20% by weight, from about 0.1% by weight to about 15% by weight, from about 0.5% by weight to about 10% by weight, or from about 1% by weight to about 8% by weight, based on the total weight of the SCFT.

In some embodiments, the ratio of block copolymer(s) to glycol fatty acid ester ranges from about 75:12 to 84:1, or from about 80:7 to 83:2. In one embodiment, the ratio of block copolymer(s) to glycol fatty acid ester of about 82:5.

In another embodiment, the SCFT is substantially free of PEG, PEG fatty acid esters, PEG stearates, and/or glycerol stearates.

### Fragrance(s) or Perfume(s)

Fragrance (perfume) refers to and includes any fragrant substance or mixture of substances including natural (obtained by extraction of flowers, herbs, leaves, roots, barks, wood, blossoms or plants), artificial (mixture of natural oils or oil constituents) and synthetically produced odoriferous substances. The fragrance or perfume can be an ester, an ether, an aldehyde, a ketone, an alcohol, a hydrocarbon, or a combination thereof.

The fragrance or perfume can have, for example, a musky scent, a putrid scent, a pungent scent, a camphoraceous scent, an ethereal scent, a floral scent, a peppermint scent, or any combination thereof.

In one embodiment, the fragrance or perfume can comprise methyl formate, methyl acetate, methyl butyrate, ethyl butyrate, isoamyl acetate, pentyl butyrate, pentyl pentanoate, octyl acetate, myrcene, geraniol, nerol, citral, citronellol, linalool, nerolidol, limonene, camphor, terpineol, alpha-ionone, thujone, benzaldehyde, eugenol, cinnamaldehyde, ethyl maltol, vanillin, anisole, anethole, estragole, thymol, indole, pyridine, furaneol, 1-hexanol, cis-3-hexenal, furfural, hexyl cinnamaldehyde, fructone, hexyl acetate, ethyl methyl phenyl glycidate, dihydrojasmone, oct-1-en-3-one, 2-acetyl-1-pyrroline, 6-acetyl-2,3,4,5-tetrahydropyridine, gamma-decalactone, gamma-nonalactone, delta-octalone, jasmine lactone, massoia lactone, wine lactone, sotolon, grapefruit mercaptan, methanthiol, methyl phosphine, dimethyl phosphine, nerolin, 2,4,6-trichloroanisole, or any combination thereof.

In one embodiment, the fragrance or perfume can contain, for example, a linear terpene, a cyclic terpene, an aromatic compound, a lactone, a thiol, or any combination thereof.

In one embodiment, the fragrance or perfume is High Five ACM 190991 F (Firmenich), Super Soft Pop 190870 (Firmenich), Mayflowers TD 485531 EB (Firmenich), Popscent 259366 (Firmenich), Azulete Neat Oil 495389 (Firmenich), or any combination thereof. Other art-known fragrances, or any fragrance commercially available from a fragrance supplier (e.g. Firmenich, Givaudan, International Flavors and Fragrances (IFF), Oriental etc.), or combinations of such fragrances, may also suitably be used in the SCFTs, compositions, and methods disclosed herein.

In one embodiment, at least some of the fragrance or perfume can be encapsulated, for example, in a microcapsule or a nanocapsule. In another embodiment, all of the fragrance or perfume can be encapsulated. Examples of encapsulated fragrances are described in, for example, U.S. Pat. Nos. 6,024,943, 6,056,949, 6,194,375, 6,458,754 and 8,426,353, and US 2011/0224127 A1, each of which is incorporated by reference in its entirety.

The microcapsules and nanocapsules can be water-soluble or water-insoluble.

In one embodiment, at least some of the fragrance or perfume can be free and not encapsulated. In another embodiment, all of the fragrance or perfume can be free and not encapsulated.

In another embodiment, the fragrance comprises both a free fragrance and an encapsulated fragrance.

The total amount of fragrance or perfume in the SCFT can range, for example, from about 0.1% by weight to about 25.0% by weight, or from about 0.1% by weight to about 15% by weight, based on the total weight of the SCFT.

The amount of free fragrance or perfume in the SCFT can range from about 0.1% by weight to about 20% by weight, from about 0.1% by weight to about 15% by weight, or from about 0.1% by weight to about 10% by weight.

The amount of encapsulated fragrance or perfume in the SCFT can range from about 0.1% by weight to about 15% by weight, from about 0.1% by weight to about 10% by weight, or from about 0.1% by weight to about 5% by weight. The weight percent as used herein is based on the total weight of the SCFT and applies only to the encapsulated fragrance or perfume in the SCFT, excluding water.

### Colorant(s)

In some embodiments, the SCFT does not contain a colorant.

In some embodiments, the SCFT contains one or more colorants, for example, polymers, dyes, water-soluble polymers, water-soluble dyes, water-insoluble polymers, water-insoluble dyes or a mixture thereof.

The colorant(s) include those that are known in the art, or commercially available from dye or chemical manufacturers.

The color of the colorant(s) is not limited, and can be, for example, red, orange, yellow, blue, indigo, violet, or any combination thereof.

The colorant(s) can be, for example, one or more Milliken LIQUITINT® colorants: VIOLET LS, ROYAL MC, BLUE HP, BLUE MC, AQUAMARINE, GREEN HMC, BRIGHT YELLOW, YELLOW LP, YELLOW BL, BRILLIANT ORAGNE, CRIMSON, RED MX, PINK AL, RED BL, RED ST, or any combination thereof.

The colorant(s) can be, for example, one or more of Acid Blue 80, Acid Red 52, and Acid Violet 48.

Acid Blue 48 has the chemical structure:

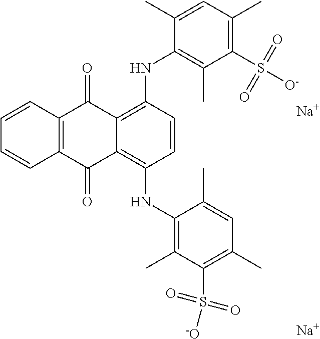

Acid Red 52 has the chemical structure:

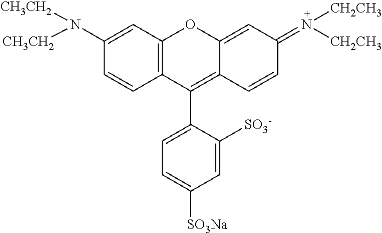

Acid Violet 48 has the chemical structure:

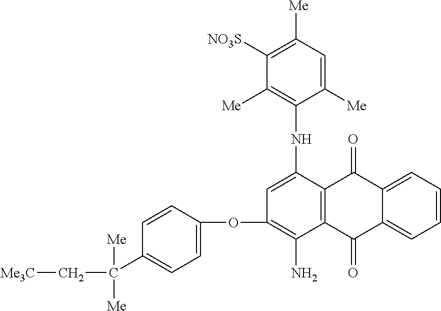

The total amount of the one or more colorant(s) that can be included in the SCFT, for example, can range from about 0.00001% by weight to about 0.15% by weight, from about 0.0001% by weight to about 0.1% by weight, from about 0.001% by weight to about 0.1% by weight, or from about 0.005% by weight to about 0.1% by weight, based on the total weight of the SCFT. The total amount of colorant(s) in the SCFT can be, for example, about 0.0001% by weight, about 0.001% by weight, about 0.01% by weight, about 0.05% by weight, about 0.08% by weight, or about 0.1% by weight, based on the total weight of the SCFT.

### Filler(s)

In some embodiments, the SCFT does not contain a filler.

In some embodiments, the SCFT contains one or more fillers, for example, a clay. In one embodiment, the clay is a smectite clay, e.g., a Bentonite clay, Beidellite clay, a Hectorite clay, a Laponite clay, a Montmorillonite clay, a Nontronite clay, a Saponite clay, a Sauconite, clay, or any combination thereof. In one embodiment, the clay is a Bentonite clay.

In other embodiments, the filler can be a starch material. The starch material can comprise starch derived from corn, potato, tapioca, cereal grain, rice, beans, peas or a combination thereof. Cereal grain includes, but is not limited to, corn, rice, wheat, barley, sorghum, millet, oats, rye, and combinations thereof.

The total amount of the one or more filler(s) that can be contained in the SCFT, for example, can range from about 0.0% by weight to about 40% by weight, about 0.001% by weight to about 30% by weight, about 0.01% by weight to about 25% by weight, about 0.1% by weight to about 20% by weight, or about 1% by weight to about 15% by weight, based on the total weight of the SCFT.

In some embodiments, the ratio of block copolymer(s) to filler ranges from about 60:30 to 85:9, or from about 80:14 to 84:10. In one embodiment, the ratio of block copolymer(s) to filler of about 82:12.

In one embodiment, the ratio of block copolymer(s) to filler to glycol fatty acid ester(s) is about 82:12:5. In another embodiment, the SCFT comprises a ratio of block copolymer(s) to Bentonite clay to ethylene glycol monostearate of about 82:12:5.

### Methods of Making SCFTs

The present disclosure provides a method of making a SCFT comprising mixing and melting a block copolymer, a glycol fatty acid ester, and a fragrance to form a mixture, allowing the mixture to shape, and hardening the shaped mixture. In some embodiments, the method further comprises adding fragrance, and optionally colorant and filler into the mixture after melting.

The SCFTs can be made, for example, by first heating the block copolymer(s) (optionally in the presence of one or more or all of the ingredients in the SCFTs) until the block copolymer(s) melt, and then adding and/or mixing with the remaining ingredients of the SCFTs (if any). For example, the glycol fatty acid ester, the fragrance, colorant, filler, or combinations thereof may be added to the block copolymer(s) before or after the block copolymer(s) is melted. In some embodiments, the glycol fatty acid ester is melted before being added to the melted block copolymer(s).

In some embodiments, the block copolymer(s) and any other ingredients of the SCFT are heated to form a melt, optionally with mixing, e.g., by using an overhead mixer with a 3-bladed propeller or a high shear mixer. The agitation rate can be, for example, less than about 500 revolutions per minute (“rpm”), or less than about 400 rpm, or less than about 300 rpm. Then, the remaining ingredients (if any), are added into and blended with the molten mixture. The mixtures are allowed to shape and harden. In one embodiment, the molten mixture is shaped into drops, released to a surface, and allowed to cool and harden to form pastilles. In some embodiments, the surface comprises a polymeric film.

In some embodiments, the SCFTs can be in the form of tablets or pellets. To make tablets or pellets, the ingredients in the SCFTs can be blended together, for example, at room temperature, and compressed to form tablets or pellets. The blends can be dry powder blends.

The tablets or pellets can be formed using any known press, for example, a rotary press. The compression force can range, for example, from about 1,000 pounds to about 15,000 pounds. The tableting compression force can be, for example, about 2,000 pounds, about 3,000 pounds, about 4,000 pounds, about 5,000 pounds, about 6,000 pounds, about 7,000 pounds, about 8,000 pounds, about 9,000 pounds, about 10,000 pounds, about 11,000 pounds, about 12,000 pounds, about 13,000 pounds, or about 14,000 pounds.

In another embodiment is provided a method for making a laundry detergent composition comprising blending, mixing or combining SCFTs of the present disclosure and a detergent. The detergent comprises at least one detersive surfactant. The ratio of detergent to SCFT can be, for example, about 100:1 to about 1:100, on a weight to weight basis. The ratio of detergent to SCFT can be, for example, about 90:1, about 80:1, about 70:1, about 60:1, about 50:1, about 40:1, about 30:1, about 20:1, about 10:1, about 1:10, about 1:20, about 1:30, about 1:40, about 1:50, about 1:60, about 1:70, about 1:80, or about 1:90, on a weight to weight basis. The ratio of detergent to SCFT can be, for example, about 55:10, or about 50:15, or about 45:18, or about 42:20, or about 40:25, on a weight to weight basis.

In one embodiment is provided a SCFT made by a method as described herein.

In another embodiment is provided laundry detergent composition made by a method comprising blending or mixing or combining a SCFT and a detergent. The detergent can comprise a surfactant.

The ratio of detergent to SCFT can range from about 100:1 to about 1:100, on a weight to weight basis. The ratio of detergent to SCFT can be, for example, about 90:1, about 80:1, about 70:1, about 60:1, about 50:1, about 40:1, about 30:1, about 20:1, about 10:1, about 1:10, about 1:20, about 1:30, about 1:40, about 1:50, about 1:60, about 1:70, about 1:80, or about 1:90, on a weight to weight basis. The ratio of detergent to SCFT can be, for example, about 55:10, or about 50:15, or about 45:18, or about 42:20, or about 40:25, on a weight to weight basis.

### Unit Dose(s) SCFTs

In some embodiments, the SCFTs of the present disclosure are provided in a unit dose.

In one embodiment, a unit dose SCFT comprises one or more SCFTs in the form of a pastille, a granule, a pellet, a powder, a pulverized powder, a tablet, or crystalline (e.g., crystal(s)).

In one embodiment, a unit dose SCFT comprises a water-soluble container and a SCFT. The water-soluble container can comprise a single-chamber or a multi-chamber container. In one embodiment, the water-soluble container comprises a water-soluble polymer or film, including, but not limited to, polyvinylalcohol (PVOH) or a PVOH film.

In one embodiment, a unit dose SCFT comprises one or more SCFTs and one or more additional ingredients (e.g., sodium chloride, fragrance, or combinations thereof) mixed or blended together. In another embodiment, a unit dose SCFT comprises one or more SCFTs and one or more additional ingredients mixed or blended together and contained within a water-soluble container.

In another embodiment is provided a unit dose laundry detergent composition.

In one embodiment, a unit dose laundry detergent composition can comprise a SCFT and a detergent. The detergent can comprise at least one detersive surfactant.

All detersive surfactants suitable for use in a detergent (e.g., laundry application, etc.) composition can be used herein. The detersive surfactants include, but are not limited to an anionic surfactant, a nonionic surfactant, a cationic surfactant, an ampholytic surfactant, a zwitterionic surfactant, or mixtures thereof.

In another embodiment, a unit dose laundry detergent composition can comprise a water-soluble container, a SCFT, and a detergent comprising at least one detersive surfactant.

In a further embodiment, a unit dose laundry detergent composition can comprise a water-soluble container, a SCFT, a detergent comprising at least one detersive surfactant, and optionally a solid material. The solid material can be, for example, sodium chloride, a fragrance, or combinations thereof.

In further embodiments, unit dose SCFTs and unit dose laundry detergent compositions can comprise one or more additional ingredients, which include, but are not limited to, a salt, an inorganic alkali metal salt, an inorganic alkaline earth metal salt, an organic alkali metal salt, an organic alkaline earth metal salt, an acid, a base, a carbohydrate, a silicate, a urea, a polymer, a fragrance, a colorant, a colorant stabilizer, a flow aid, a builder, a solubilizer, an activator, an antioxidant, an inhibitor, a binder, an enzyme protecting agent, an amino acid, a protein, a surfactant, an electrolyte, a bleaching agent, a bluing agent, a caking inhibitor, and combinations thereof. Examples of additional ingredients, suitable for use in accordance with the unit doses of the present disclosure are described in U.S. Patent Application Nos. 2013/0095717 A1; 2016/0160156 A1; and 2016/0160157 A1, each of which is incorporated herein by reference in its entirety.

In one embodiment, a unit dose laundry detergent composition comprises one or more SCFTs, a detergent comprising at least one detersive surfactant, and one or more additional ingredients mixed or blended together. In another embodiment, a unit dose laundry detergent composition comprises one or more SCFTs, a detergent comprising at least one detersive surfactant, and one or more additional ingredients mixed or blended together and contained within a water-soluble container as described herein. In a further embodiment, a unit dose laundry detergent composition comprises one or more SCFTs, a detergent comprising at least one detersive surfactant, and one or more additional ingredients contained separately within a water-soluble container. In another embodiment, a unit dose laundry detergent composition comprises one or more SCFTs and a detergent in separate chambers within a multi-chamber water-soluble container.

In one embodiment is provided a method of making a unit dose SCFT comprising enclosing all the ingredients within a water-soluble container. The container may be a single-chamber container (e.g., pouch), or multi-chamber container.

In one embodiment is provided a method of making a unit dose laundry detergent composition comprising mixing or blending all the ingredients and enclosing them within a water-soluble container. In another embodiment is provided a method of making a unit dose laundry detergent composition comprising enclosing the SCFT and detergent in separate chambers within a water-soluble container.

An exemplary unit dose laundry detergent composition can be prepared using the liquid laundry detergent formulations shown in TABLE 1 and a SCFT of the present disclosure. Liquid laundry detergent formulations were prepared as follows:

TABLE 1
Liquid compositions formulations

| Component | 1 | 2 | 3 | 4 | 5 | 6 | 7 |
|---|---|---|---|---|---|---|---|
| C₁₂-C₁₅ alcohol | 20.0000 | 20.0000 | 20.0000 | 20.0000 | 20.0000 | 20.0000 | 20.0000 |
| ethoxylate 7EO | | | | | | | |
| hexylene glycol | 29.0364 | 28.5364 | 28.0364 | 27.5364 | 27.0364 | 27.5364 | 27.0364 |
| glycerin | 5.0000 | 5.0000 | 5.0000 | 5.0000 | 5.0000 | 5.0000 | 5.0000 |
| monoethanolamine | 1.7000 | 1.7000 | 1.7000 | 1.7000 | 1.7000 | 1.7000 | 1.7000 |
| deionized water | 6.1200 | 6.1200 | 6.1200 | 6.1200 | 6.1200 | 6.1200 | 6.1200 |
| sodium sulfite | 0.1000 | 0.1000 | 0.1000 | 0.1000 | 0.1000 | 0.1000 | 0.1000 |
| linear alkyl | 5.0000 | 5.0000 | 5.0000 | 5.0000 | 5.0000 | 5.0000 | 5.0000 |
| benzene sulfonic | | | | | | | |
| acid (LAS) | | | | | | | |
| coconut oil fatty | 5.0000 | 5.0000 | 5.0000 | 5.0000 | 5.0000 | 5.0000 | 5.0000 |
| acid | | | | | | | |
| sodium lauryl | 21.4286 | 21.4286 | 21.4286 | 21.4286 | 21.4286 | 21.4286 | 21.4286 |
| ether sulphate 2 | | | | | | | |
| EO | | | | | | | |
| Soil-releasing | 2.5000 | 2.5000 | 2.5000 | 2.5000 | 2.5000 | 2.5000 | 2.5000 |
| polymer | | | | | | | |
| ALCOSPERSE ® | 0.0000 | 0.5000 | 1.0000 | 1.5000 | 2.0000 | 0.0000 | 0.0000 |
| 747 | | | | | | | |
| ACUSOL ® 445N | 0.0000 | 0.0000 | 0.0000 | 0.0000 | 0.0000 | 1.5000 | 0.0000 |
| DEQUEST SPE | 0.0000 | 0.0000 | 0.0000 | 0.0000 | 0.0000 | 0.0000 | 2.0000 |
| 1202 | | | | | | | |
| Enzymes | 2.8000 | 2.8000 | 2.8000 | 2.8000 | 2.8000 | 2.8000 | 2.8000 |
| Fragrance | 1.0000 | 1.0000 | 1.0000 | 1.0000 | 1.0000 | 1.0000 | 1.0000 |
| Dyes | 0.3150 | 0.3150 | 0.3150 | 0.3150 | 0.3150 | 0.3150 | 0.3150 |
| Total | 100.000 | 100.000 | 100.000 | 100.000 | 100.000 | 100.000 | 100.000 |

The representative unit dose laundry detergent compositions can contain the liquid laundry detergent formulations shown in TABLE 1 and a SCFT in the same or separate chambers within a water-soluble container.

### Aerated Solid Compositions for Fabric Treatment (“ASCFTs”)

The present disclosure further provides aerated solid compositions for fabric treatment (“ASCFTs”). The ASCFTs can be used, for example to treat a fabric or a textile.

The ASCFTs of the present disclosure are desirably solid at about 25° C. and exhibit increased solubility in cold, warm, and hot water, and can deliver long lasting fragrance impression.

In one embodiment is provided an ASCFT having a density of at least about 1%, or at least about 2%, or at least about 3%, or at least about 4%, or at least about 5%, or at least about 6%, or at least about 7%, or at least about 8%, or at least about 9%, or at least about 10%, or at least about 11%, or at least about 12%, or at least about 13%, or at least about 14%, or at least about 15%, or at least about 16%, or at least about 17%, or at least about 18%, or at least about 19%, or at least about 20% less than the density of a reference composition without entrapped air. The term “reference composition” used herein means an otherwise identical composition but without entrapped air.

In one embodiment is provided an ASCFT wherein the water solubility is increased by at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, or at least about 80% as compared to a reference composition without entrapped air, as measured by a stir-bar method at 59 □F in 120 ppm Ca²⁺/Mg²⁺ water, wherein the ratio of Ca²⁺:Mg²⁺ is about 3:1.

In one embodiment, the ASCFT solubilizes in about 15 minutes or less, or about 14 minutes or less, or about 13 minutes or less, or about 12 minutes or less, or about 11 minutes or less, or about 10 minutes or less, or about 9 minutes or less, or about 8 minutes or less, or about 7 minutes or less, or about 6 minutes or less, or about 5 minutes or less as measured by a stir-bar method at 59 □F in 120 ppm Ca′/Mg²⁺ water, wherein the ratio of Ca²⁺:Mg²⁺ is 3:1.

In one embodiment, the ASCFT solubilizes in about 7 minutes or less as measured by a stir-bar method at 59 □F in 120 ppm Ca²⁺/Mg²⁺ water, wherein the ratio of Ca²⁺:Mg²⁺ is 3:1.

In another embodiment is provided an ASCFT having a strength ranging from about 5 Newtons to about 50 Newtons, about 7 Newtons to about 35 Newtons, or about 9 Newtons to about 35 Newtons of required force to break the solid composition.

In one embodiment, the ASCFT has a strength of at least about 10 Newtons of required force to break the solid composition.

In a further embodiment is provided an ASCFT having a melting point ranging from about 32 □C to about 80 □C, about 40 □C to about 70 □C, about 42 □C to about 65 □C, or about 43 □C to about 61 □C.

The term “sufficient amount of entrapped air” refers to entrapped air/gaseous material in an amount sufficient to lower the density, increase water solubility, achieve the strength, and/or achieve melting point of the composition, as described above. In preferred embodiments, the sufficient amount of entrapped air/gaseous material is the amount of air/gaseous material necessary to make the composition, when it is in a liquid stage, saturated with the air air/gaseous material. In some embodiments, introducing air/gaseous material into the liquid composition is conducted under pressure.

In one embodiment, the ASCFT comprises a block copolymer, a glycol fatty acid ester, a fragrance, and a sufficient amount of entrapped air. The block copolymer, the glycol fatty acid ester, the fragrance are described above.

In some embodiments, the ASCFT optionally comprises a colorant and/or a filler as described above. The ASCFT can further include other additives commonly included in a fabric treatment composition.

In one embodiment, the ASCFT comprises a ratio of block copolymer(s) to filler to glycol fatty acid ester(s) of about 82:12:5. In another embodiment, the ASCFT comprises a ratio of block copolymer(s) to Bentonite clay to ethylene glycol monostearate of about 82:12:5.

In one embodiment, the ASCFT does not include PEG.

In another embodiment, the ASCFT comprises a PEG, a fragrance, and a sufficient amount of entrapped air. The ingredients in the ASCFT can be homogeneously or heterogeneously mixed. In some embodiments, the ingredients in the ASCFT are homogeneously mixed.

### Block Copolymer(s)

The ASCFT of the present disclosure comprises one or more block copolymer(s) as described above.

The ASCFT can contain a total amount of the block copolymer(s) ranging from about 40% by weight to about 99% by weight, from about 55% by weight to about 99% by weight, from about 60% by weight to about 99% by weight, from about 65% to about 99% by weight, from about 70% to about 99% by weight, from about 75% by weight to about 99% by weight, from about 80% by weight to about 99% by weight, from about 85% by weight to about 99% by weight, from about 70% by weight to about 95% by weight, from about 75% by weight to about 95% by weight, from about 80% by weight to about 95% by weight, from about 85% by weight to about 95% by weight, from about 70% by weight to about 90% by weight, from about 75% by weight to about 90% by weight, from about 80% by weight to about 90% by weight, or from about 75% by weight to about 85% by weight, based on the weight of the ASCFT.

### Glycol Fatty Acid Ester(s)

The ASCFT of the present disclosure comprises one or more glycol fatty acid ester(s) as described above.

In some embodiments, the glycol fatty acid ester is ethylene glycol monostearate.

In some embodiments, the ASCFT can contain, for example, a total amount of glycol fatty acid ester ranging from about 0.05% by weight to about 25% by weight, from about 0.05% by weight to about 20% by weight, from about 0.1% by weight to about 15% by weight, from about 0.5% by weight to about 10% by weight, or from about 1% by weight to about 8% by weight, based on the total weight of the ASCFT.

In one embodiment, the ASCFT comprises a ratio of block copolymer(s) to glycol fatty acid ester of about 82:5.

### Fragrance(s) or Perfume(s)

The ASCFT of the present disclosure comprises one or more fragrances or perfumes as described above.

In one embodiment, at least some of the fragrance or perfume can be encapsulated, for example, in a microcapsule or a nanocapsule. In another embodiment, all of the fragrance or perfume can be encapsulated. The microcapsules and nanocapsules can be water-soluble or water-insoluble.

In one embodiment, at least some of the fragrance or perfume can be free and not encapsulated. In another embodiment, all of the fragrance or perfume can be free and not encapsulated.

The total amount of fragrance or perfume in the ASCFT can range, for example, from about 0.1% by weight to about 25.0% by weight, or from about 0.1% by weight to about 15% by weight, based on the total weight of the ASCFT.

The amount of free fragrance or perfume in the ASCFT can range from about 0.1% by weight to about 20% by weight, from about 0.1% by weight to about 15% by weight, or from about 0.1% by weight to about 10% by weight.

The amount of encapsulated fragrance or perfume in the ASCFT can range from about 0.1% by weight to about 15% by weight, from about 0.1% by weight to about 10% by weight, or from about 0.1% by weight to about 5% by weight.

### Entrapped or Incorporated Air

The ASCFT of the present disclosure comprises a sufficient amount of entrapped or incorporated air or gaseous materials.

In one embodiment, a sufficient amount of air or gaseous material is incorporated or entrapped by methods described herein, including but not limited to, aeration, sparging, and agitation.

In one embodiment, a sufficient amount of air or gaseous material is the amount required to decrease the density of the composition by at least about 1%, or by at least about 2%, or by at least about 3%, or by at least about 4%, or by at least about 5%, or by at least about 6%, or by at least about 7%, or by at least about 8%, or by at least about 9%, or by at least about 10%, or by at least about 11%, or by at least about 12%, or by at least about 13%, or by at least about 14%, or by at least about 15%, or by at least about 16%, or by at least about 17%, or by at least about 18%, or by at least about 19%, or by at least about 20% less than the density of a reference composition without entrapped air.

In one embodiment, a sufficient amount of air or gaseous material is the amount required to increase the volume of the composition by a value ranging from about 0.1% to about 300%, or from about 0.1% to about 200%, or from about 0.1% to about 100%, or from about 0.1% to about 75%, or from about 0.1% to about 50%.

In one embodiment, a sufficient amount of air or gaseous material is the amount required to increase the volume of the composition by at least about 0.1%, or by at least about 1%, or by at least about 5%, or by at least about 10%, or by at least about 20%, or by at least about 30%, or by at least about 40%, or by at least about 50%, or by at least about 100%, or by at least about 200%, or by at least about 300%.

### PEG(s)

In one embodiment, the present disclosure provides an ASCFT that comprises (a) a polyethylene glycol (PEG); (b) a fragrance; and (c) a sufficient amount of entrapped air.

The PEG can have a weight average molecular weight (g/mol) ranging, for example, from about 600 to about 10,000,000. Suitable PEGs can have a weight average molecular weight of, for example, about 600, about 700, about 800, about 900, about 1,000, about 2,000, about 3,000, about 4,000, about 5,000, about 6,000, about 7,000, about 8,000, about 9,000, about 10,000, about 11,000, about 15,000, about 20,000, about 25,000, about 30,000, about 35,000, about 40,000, about 45,000, about 50,000, about 55,000, about 60,000, about 65,000, about 70,000, about 75,000, about 80,000, about 85,000 about 90,000, about 95,000, about 100,000, about 200,000, about 300,000, about 400,000, about 500,000, about 600,000, about 700,000, about 800,000, about 900,000, about 1,000,000, about 2,000,000, about 3,000,000, about 4,000,000, about 5,000,000, about 6,000,000, about 7,000,000, about 8,000,000, about 9,000,000 or about 10,000,000.

In some embodiments, the PEG can have a weight average molecular weight (g/mol) ranging, for example, from about 3,000 to about 12,000, from about 3,000 to about 10,000, from about 3,000 to about 8,000, from about 3,000 to about 6,000, or from about 3,000 to about 4,000. The PEG can have a weight average molecular weight (g/mol) ranging, for example, from about 4,000 to about 12,000, from about 6,000 to about 12,000, from about 8,000 to about 12,000, from about 10,000 to about 12,000 or about 11,000 to about 12,000.

Examples of PEGs are found in U.S. Pat. No. 7,871,976, which is incorporated by reference in its entirety.

Exemplary PEGs include, for example, PEG 600, PEG 700, PEG 800, PEG 900, PEG 1,000, PEG 2,000, PEG 3,000, PEG 4,000, PEG 5,000, PEG 6,000, PEG 7,000, PEG 8,000, PEG 9,000, or PEG 10,000.

The total amount of the one or more PEGs contained in the ASCFT, for example, can range from about 65% by weight to about 95% by weight, based on the total weight of the ASCFT. The total amount of the one or more PEGs can be, for example, about 66% by weight, about 67% by weight, about 68% by weight, about 69% by weight, about 70% by weight, about 71% by weight, about 72% by weight, about 73% by weight, about 74% by weight, about 75% by weight, about 76% by weight, about 77% by weight, about 78% by weight, or about 79% by weight, or about 80% by weight, or about 81% by weight, or about 82% by weight, or about 83% by weight, or about 84% by weight, or about 85% by weight, or about 86% by weight, or about 87% by weight, or about 88% by weight, or about 89% by weight, or about 90% by weight, or about 91% by weight, or about 92% by weight, or about 93% by weight, or about 94% by weight, or about 95% by weight, based on the total weight of the ASCFT.

### Colorant(s)

In some embodiments, the ASCFT does not contain a colorant.

In some embodiments, the ASCFT can optionally contain a colorant as described above.

The total amount of the one or more colorant(s) that can be contained in the ASCFT, for example, can range from about 0.00001% by weight to about 0.15% by weight, from about 0.0001% by weight to about 0.1% by weight, from about 0.001% by weight to about 0.1% by weight, or from about 0.005% by weight to about 0.1% by weight, based on the total weight of the ASCFT. The total amount of colorant(s) in the ASCFT can be, for example, about 0.0001% by weight, about 0.001% by weight, about 0.01% by weight, about 0.05% by weight, about 0.08% by weight, or about 0.1% by weight, based on the total weight of the ASCFT.

### Filler(s)

In some embodiments, the ASCFT does not contain a filler.

In some embodiments, the ASCFT contains one or more fillers as described above.

The total amount of the one or more filler(s) that can be contained in the ASCFT, for example, can range from about 0.0% by weight to about 40% by weight, about 0.001% by weight to about 30% by weight, about 0.01% by weight to about 25% by weight, about 0.1% by weight to about 20% by weight, or about 0.1% by weight to about 15% by weight, based on the total weight of the ASCFT.

In one embodiment, the ASCFT comprises a ratio of block copolymer(s) to filler of about 82:5.

### Methods of Making ASCFTs

The present disclosure provides a method of making an ASCFT comprising mixing and melting a block copolymer, a glycol fatty acid ester, and a fragrance to form a mixture, incorporating or entrapping air or gaseous material into the mixture, allowing the mixture to shape, and hardening the shaped mixture. In some embodiments, the method further comprises adding fragrance, and optionally colorant and filler into the mixture after melting.

The ASCFTs can be made, for example, by first heating the block copolymer(s) (optionally in the presence of one or more or all of the ingredients in the ASCFT) until the block copolymer(s) or the mixture melts, adding and/or mixing with the remaining ingredients of the ASCFT (if any), and aerating, i.e., incorporating or entrapping air or gaseous material into, the mixture. For example, the glycol fatty acid ester, the fragrance, colorant, filler, or combinations thereof may be added to the block copolymer(s) before or after the block copolymer(s) is melted. In some embodiments, the glycol fatty acid ester is melted before being added to the melted block copolymer(s).

In some embodiments, the block copolymer(s) and any other ingredients of the ASCFT are heated to form a melt, and optionally mixed. Then, the remaining ingredients (if any) are added into and blended with the molten mixture. Air or gaseous material is then incorporated into or entrapped in the mixture. The mixtures are allowed to shape and harden. In one embodiment, the mixtures are shaped into drops, released to a surface, and allowed to cool and harden to form pastilles. In some embodiments, the surface comprises a polymeric film.

The present disclosure also provides a method of making an ASCFT comprising mixing and melting a PEG and a fragrance to form a mixture, incorporating or entrapping air or gaseous material into the mixture, allowing the mixture to shape, and hardening the shaped mixture. In some embodiments, the method further comprises adding fragrance, and optionally colorant and filler into the mixture after melting.

In some embodiments, the ASCFTs can be made, for example, by first heating a PEG (optionally in the presence of one more or all of the ingredients in the ASCFT) until the PEG or the mixture melts, adding and/or mixing with the remaining ingredients of the ASCFT (if any), and aerating, i.e., incorporating or entrapping air or gaseous material into, the mixture. For example, the fragrance, colorant, filler, or combinations thereof may be added to the PEG(s) before or after the PEG(s) is melted.

In some embodiments, the PEG(s) and any other ingredients are heated to form a melt, and optionally mixed. Then, the remaining ingredients (if any) are added into and blended with the molten mixture. Air or gaseous material is then incorporated into or entrapped in the mixture. The mixtures are allowed to shape and harden. In one embodiment, the mixtures are shaped into drops, released to a surface, and allowed to cool and harden to form pastilles. In some embodiments, the surface comprises a polymeric film.

Air or gaseous material can be entrapped or incorporated into an ASCFT by adding air or gaseous material to the ASCFT while the ASCFT is in liquid, melted, or molten form.

The air or gaseous material can comprise, for example, air, nitrogen, argon, helium, carbon dioxide, or combinations thereof.

In some embodiments, the air or gaseous material is incorporated into or entrapped in the ASCFT by agitating or whipping the mixture of ingredients. Agitating or whipping the mixture can be done by, for example, using a mixer. The mixer can be, for example, a low-shear overhead mixer with a 3-bladed propeller. Agitating or whipping the mixture can also be done using a high-shear mixing process, batch mixing, and in-line mixing with static or high-shear mixers.

The agitation or whipping rate can be, for example, greater than about 200 revolutions per minute (“rpm”), or greater than about 300 rpm, or greater than about 400 rpm, or greater than about 500 rpm, or greater than about 600 rpm, or greater than about 700 rpm, or greater than about 800 rpm, or greater than about 900 rpm, or greater than about 1000 rpm, or greater than about 1100 rpm, or greater than about 1200 rpm, or greater than about 1300 rpm, or greater than about 1400 rpm, or greater than about 1500 rpm, or greater than about 2000 rpm, or greater than about 3000 rpm, or greater than about 4000 rpm, or greater than about 5000 rpm.

In some embodiments, the air or gaseous material is incorporated into or entrapped in the ASCFT by sparging air or gaseous material into the mixture. Sparging air or gaseous material into the mixture can be done by, for example, bubbling or injecting the air or gaseous material into the mixture. The air or gaseous material can be bubbled through or injected into the mixture by, for example, using a sparger, a diffuser, or an aerator.

In some embodiments, the air or gaseous material is incorporated into or entrapped in the ASCFT by, for example, using an aerator. The aerator can be, for example, a waterfall aerator, a bubble aerator, a mechanical aerator, a pressure aerator, or combinations thereof.

In one embodiment, the mixture is aerated, agitated, whipped, and/or sparged for a sufficient amount of time. A sufficient amount of time can be, for example, the amount of time required to cause the color of the mixture to lighten. A sufficient amount of time can depend on the mixing conditions. For example, a sufficient amount of time can be lower with a higher agitation or whipping rate, and conversely, a sufficient amount of time can be higher with a lower agitation or whipping rate.

A sufficient amount of time can be, for example, at least about 1 second, or at least about 5 seconds, or at least about 10 seconds, or at least about 30 seconds, or at least about 1 minute, or at least about 2 minutes, or at least about 3 minutes, or at least about 5 minutes, or at least about 10 minutes, or at least about 15 minutes, or at least about 20 minutes, or at least about 30 minutes, or at least about 45 minutes, or at least about 60 minutes.

A sufficient amount of time can also be, for example, the amount of time required to decrease the density of the mixture by at least about 1%, or by at least about 2%, or by at least about 3%, or by at least about 4%, or by at least about 5%, or by at least about 6%, or by at least about 7%, or by at least about 8%, or by at least about 9%, or by at least about 10%, or by at least about 11%, or by at least about 12%, or by at least about 13%, or by at least about 14%, or by at least about 15%, or by at least about 16%, or by at least about 17%, or by at least about 18%, or by at least about 19%, or by at least about 20% less than the density of a reference composition without entrapped air. A reference composition without entrapped air can comprise, for example, a SCFT as described herein. The density of the mixture can be measured by methods known in the art by a person of ordinary skill in the art.

A sufficient amount of time can also be, for example, the amount of time required to increase the volume of the mixture by a value ranging from about 0.1% to about 300%, or from about 0.1% to about 200%, or from about 0.1% to about 100%, or from about 0.1% to about 75%, or from about 0.1% to about 50%.

A sufficient amount of time can also be, for example, the amount of time required to increase the volume of the mixture by at least about 0.1%, or by at least about 1%, or by at least about 5%, or by at least about 10%, or by at least about 20%, or by at least about 30%, or by at least about 40%, or by at least about 50%, or by at least about 100%, or by at least about 200%, or by at least about 300%. The volume of the mixture can be measured by methods known in the art by a person of ordinary skill in the art.

The amount of air or gaseous material incorporated or entrapped in the mixture can be measured by methods known in the art by a person of ordinary skill in the art. The amount of air or gaseous material incorporated or entrapped in the mixture can be measured, for example, by measuring the volume of a batch of the mixture before incorporating or entrapping air or gaseous material, measuring the volume of the same batch of the mixture after incorporating or entrapping air or gaseous material, and comparing the volume measurements, wherein the increase in volume after incorporating or entrapping air or gaseous material represents the volume of the incorporated or entrapped air or gaseous material.

A sufficient amount of time can vary depending on the rate of aeration, sparging, agitation, or whipping. For example, a sufficient amount of time can decrease as the rate of aeration, sparging, agitation, or whipping increases, and vice versa.

In some embodiments, the ASCFTs can be in the form of tablets or pellets. To make tablets or pellets, the ingredients in the ASCFTs can be blended together, for example, at room temperature, and compressed to form tablets or pellets.

The tablets or pellets can be formed using any known press, for example, a rotary press. The compression force can range, for example, from about 1,000 pounds to about 15,000 pounds. The tableting compression force can be, for example, about 2,000 pounds, about 3,000 pounds, about 4,000 pounds, about 5,000 pounds, about 6,000 pounds, about 7,000 pounds, about 8,000 pounds, about 9,000 pounds, about 10,000 pounds, about 11,000 pounds, about 12,000 pounds, about 13,000 pounds, or about 14,000 pounds.

In another embodiment is provided a method for making a laundry detergent composition comprising blending, mixing or combining an ASCFT of the present disclosure and a detergent. The detergent comprises at least on detersive surfactant. A ratio of detergent to ASCFT can be, for example, about 100:1 to about 1:100, on a weight to weight basis. The ratio of detergent to ASCFT can be, for example, about 90:1, about 80:1, about 70:1, about 60:1, about 50:1, about 40:1, about 30:1, about 20:1, about 10:1, about 1:10, about 1:20, about 1:30, about 1:40, about 1:50, about 1:60, about 1:70, about 1:80, or about 1:90, on a weight to weight basis.

In one embodiment is provided an ASCFT made by a method as described herein.

In another embodiment is provided laundry detergent composition made by a method comprising blending or mixing or combining an ASCFT and a detergent comprising at least one detersive surfactant.

The ratio of detergent to ASCFT can be, for example, about 100:1 to about 1:100, about 90:1, about 80:1, about 70:1, about 60:1, about 50:1, about 40:1, about 30:1, about 20:1, about 10:1, about 1:10, about 1:20, about 1:30, about 1:40, about 1:50, about 1:60, about 1:70, about 1:80, or about 1:90, on a weight to weight basis.

### Unit Dose(s) ASCFTs

The present disclosure also provides a unit dose containing an ASCFT. The unit dose can comprise one or more ASCFTs in the form of a pastille, a granule, a pellet, a powder, a pulverized powder, a tablet, or crystalline (e.g., crystal(s)).

In one embodiment, a unit dose ASCFT can comprise a water-soluble container and an ASCFT. The water-soluble container can comprise the single-chamber or multi-chamber container. In one embodiment, the water-soluble container comprises a water-soluble polymer or film, including, but not limited to, polyvinylalcohol (PVOH) or a PVOH film.

In one embodiment, a unit dose ASCFT comprises one or more ASCFTs and one or more additional ingredients (e.g., sodium chloride, fragrance or combinations thereof) mixed or blended together. In another embodiment, a unit dose ASCFT comprises one or more ASCFTs and one or more additional ingredients mixed or blended together and contained within a water-soluble container as described herein. In a further embodiment, a unit dose ASCFT comprises one or more ASCFTs and one or more additional ingredients contained separately within a water-soluble container as described herein.

In another embodiment is provided a unit dose laundry detergent composition.

In one embodiment, a unit dose laundry detergent composition can comprise an ASCFT and a detergent comprising at least one detersive surfactant.

All detersive surfactants suitable for use in a detergent (e.g., laundry application, etc.) composition can be used herein. The detersive surfactants include, but are not limited to an anionic surfactant, a nonionic surfactant, a cationic surfactant, an ampholytic surfactant, a zwitterionic surfactant, or mixtures thereof.

In another embodiment, a unit dose laundry detergent composition can comprise a water-soluble container, an ASCFT, and a detergent, wherein the detergent comprises at least one detersive surfactant.

In a further embodiment, a unit dose laundry detergent composition can comprise a water-soluble container, an ASCFT, a detergent comprising at least one detersive surfactant, and optionally, a solid material. The solid material can be, for example, sodium chloride, a fragrance, or combinations thereof.

In another embodiment, a unit dose laundry detergent composition can comprise a water-soluble container, an ASCFT, a detergent comprising at least one detersive surfactant, and sodium chloride.

In further embodiments, unit dose ASCFTs and unit dose laundry detergent compositions can comprise additional ingredients as described above, including a salt, an inorganic alkali metal salt, an inorganic alkaline earth metal salt, an organic alkali metal salt, an organic alkaline earth metal salt, an acid, a base, a carbohydrate, a silicate, a urea, a polymer, a fragrance, a colorant, a colorant stabilizer, a flow aid, a builder, a solubilizer, an activator, an antioxidant, an inhibitor, a binder, an enzyme protecting agent, an amino acid, a protein, a surfactant, an electrolyte, a bleaching agent, a bluing agent, a caking inhibitor, and combinations thereof.

In one embodiment, a unit dose laundry detergent composition comprises a water-soluble container, one or more ASCFTs, a detergent comprising at least one detersive surfactant, and one or more additional ingredients mixed or blended together. In another embodiment, a unit dose laundry detergent composition comprises a water-soluble container, one or more ASCFTs, a detergent comprising at least one detersive surfactant, and one or more additional ingredients mixed or blended together and contained within a water-soluble container In a further embodiment, a unit dose laundry detergent composition comprises a water-soluble container, one or more ASCFTs, a detergent comprising at least one detersive surfactant, and one or more additional ingredients contained separately within a water-soluble container.

In one embodiment is provided a method of making a unit dose ASCFT comprising mixing or blending all the ingredients and enclosing them within a water-soluble container. In another embodiment is provided a method of making a unit dose ASCFT comprising enclosing an ASCFT and additional ingredients separately within a water-soluble container.

In one embodiment is provided a method of making a unit dose laundry detergent composition comprising mixing or blending an ASCFT, a detergent comprising at least one detersive surfactant, and optionally additional ingredients and enclosing them within a water-soluble container as described herein. In another embodiment is provided a method of making a unit dose laundry detergent composition comprising enclosing an ASCFT, a detergent comprising at least one detersive surfactant, and optionally additional ingredients separately within a water-soluble container as described herein.

A representative unit dose laundry detergent composition can be prepared using the liquid laundry detergent formulations shown in TABLE 1 above and an ASCFT. The compositions can contain an anti-redeposition agent such as ALCOSPERSE® 747 (AkzoNobel, Chattanooga, Tenn.), ACUSOL® 445N (Dow Chemical Company, Midland, Mich.), or DEQUEST SPE-1202 (Italmatch, Genova, Italy). The representative unit dose laundry detergent composition can contain the liquid laundry detergent formulations shown in TABLE 1 above and an ASCFT in separate chambers within a water-soluble container.

### Additional Ingredient(s)

In some embodiments, the SCFT or ASCFT may further comprises additional ingredient(s) known to be employed in compositions for fabric treatment.

The additional ingredient(s) can be, for example, a bleaching agent, a bleach activator, an enzyme, a silicone oil, an anti-re-deposition agent, an optical brightener, a greying inhibitor, a shrink inhibitor, an anti-creasing agent, a color transfer inhibitor, an anti-microbial, a germicide, a fungicide, an antioxidant, an anti-static agent, an ironing aid, a water proofing agent, an impregnation agent, a swelling agent, an anti-slip agent, a UV absorber, a corrosion inhibitor, or any combination thereof. In other embodiments, the additive can be one or more viscosity-modifying agents (e.g., silica, sodium CMC, and other agents well-known in the art to increase or decrease the viscosity of a liquid or liquid-containing suspension), one or more opacifying agents, and the like. In further embodiments, the additional ingredient(s) can be scavengers, including, for example, chlorine scavengers.

The additional ingredient(s) can be, for example, a salt. Salts can include, but are not limited to, alkali metal salt, alkaline earth metal salt, and combinations thereof.

Alkali metal salts can be, for example, salts of lithium, sodium, potassium, rubidium, cesium, francium, or any combination thereof.

Useful alkali metal salts can be, for example, alkali metal fluorides, chlorides, bromides, iodides, sulfates, bisulfates, phosphates, monohydrogen phosphates, dihydrogen phosphates, carbonates, monohydrogen carbonates, acetates, citrates, lactates, pyruvates, silicates, ascorbates, or any combination thereof.

Alkali metal salts can include, for example, sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium acetate, sodium citrate, sodium lactate, sodium tartrate, sodium silicate, sodium ascorbate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium acetate, potassium citrate, potassium lactate, potassium tartrate, potassium silicate, potassium ascorbate, or any combination thereof.

Alkaline earth metal salts include, for example, salts of beryllium, magnesium, calcium, strontium, barium, radium, or any combination thereof.

Alkaline earth metal salts can be, for example, alkaline metal fluorides, chlorides, bromides, iodides, sulfates, bisulfates, phosphates, monohydrogen phosphates, dihydrogen phosphates, carbonates, monohydrogen carbonates, acetates, citrates, lactates, pyruvates, silicates, ascorbates, or any combination thereof.

Alkaline earth metal salts can include, for example, magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium acetate, magnesium citrate, magnesium lactate, magnesium tartrate, magnesium silicate, magnesium ascorbate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, or any combination thereof.

Salts can include, for example, inorganic salts, such as inorganic alkali metal salts and inorganic alkaline earth metal salts that do not contain carbon.

Salts can include, for example, organic salts, such as organic alkali metal salts and organic alkaline earth metal salt that contain carbon.

The additional ingredient(s) can be, for example, contained in the SCFT or ASCFT in an amount ranging from about 0.00001% by weight to about 10% by weight, based on the weight of the SCFT or ASCFT.

Some examples of optional additional ingredients can be, for example, U.S. powdered sugar 10x, DISINTEX 75, polyvinylpyrrolidone K15, sodium sulfate, and sodium chloride.

### Forms, Shapes, Appearance of SCFTs or AFSCFTs

The form of the SCFT or ASCFT is not limited, and can be for example, a pastille, a granule, a pellet, a powder, a pulverized powder, a tablet, or crystalline (e.g., crystal(s)). In some embodiments, the SCFT or ASCFT can be in the form of a unit dose which can be, for example, a pastille, a granule, a pellet, a powder, a pulverized powder, a tablet, or crystalline. Pastilles, granules, pellets, powders, tablets, or crystals can, for example, be combined together. The combinations can, for example, contain pastilles, granules, pellets, powders, tablets, or crystals that have the same ingredients in the same amounts, or can, for example, contain different ingredients, or different amounts of the same ingredients.

As the size of the SCFT or ASCFT increases to a certain point, there may become a need for including a disintegrant. The disintegrant can be one or more known disintegrants. The disintegrant can be, for example, one or more of hydroxypropyl starch, lactose, corn starch, alginic acid, calcium alginate, carboxymethylcellulose calcium, carboxymethylcellulose sodium, cellulose, cellulose powdered, chitosan, colloidal silicon dioxide, corn starch and pregelatinized starch, croscarmellose sodium, crospovidone, docusate sodium, glycine, guar gum, low-substituted hydroxypropyl cellulose, magnesium aluminum silicate, methyl cellulose, microcrystalline cellulose, polacrilin potassium, povidone, sodium alginate, sodium starch glycolate, pregelatinized starch, DISINTEX 75, or any combination thereof. Disintegrant(s) can optionally be present in the SCFT or ASCFT, for example, in a total amount ranging from about 0.1% by weight to about 10% by weight, based on the total weight of the SCFT or ASCFT. The total amount of disintegrant(s) in the SCFT or ASCFT can be, for example, about 1% by weight, about 3% by weight, about 5% by weight, about 7% by weight, or about 9% by weight, based on the total weight of the SCFT or ASCFT.

The SCFT or ASCFT can be crystalline. The crystal can contain, for example, a crystal lattice that is cubic, isometric, tetragonal, orthorhombic, hexagonal, trigonal, triclinic, or monoclinic.

The shape of the SCFT or ASCFT is not limited, and can be for example, cubic, conical, spherical, hemi-spherical, an oblate spheroid, a prolate spheroid, irregular, fractal, star shaped, box shaped, heart shaped, diamond shaped, club shaped, spade shaped, disc shaped, lentil shaped, oblong shaped, or combinations thereof.

The appearance of the SCFT or ASCFT is not limited, and can be for example, shiny, dull, smooth, rough, pearlescent, opaque, translucent, or transparent.

### Laundry Detergent Compositions

The present disclosure provides a laundry detergent composition comprising a detergent and a SCFT, or an ASCFT. The detergent comprises at least one detersive surfactant. The surfactant can be, for example, a non-ionic surfactant, a cationic surfactant, an anionic surfactant, a zwitterionic surfactant, or any combination thereof.

The laundry detergent compositions can further comprise additional ingredients described herein. For example, the laundry detergent compositions can further comprise one or more salts, fragrance(s), or combinations thereof. The one or more salts can include the salts as described herein, including, but not limited to, alkali metal salts, alkaline earth metal salts, and combinations thereof.

The laundry detergent compositions may contain other ingredients commonly included in a detergent composition, for example, a builder and a beneficial agent that includes, but is not limited to comprising an enzyme, an anti-redeposition agent, an optical brightener, a biocidal agent, a foam stabilzing agent, an anti-redeposition agent, an anti-creasing agent, a color transfer inhibitor, an anti-microbial, a germicide, a fungicide, an anti-oxidant, an anti-slip agent, a pH adjusting agent, a UV absorber, a corrosion inhibitor, or a combination thereof.

### Containers

Unit dose containers and methods of manufacture thereof that are suitable for use with the SCFTs, ASCFTs, unit doses, or laundry detergent compositions of the present disclosure include those described, for example, in U.S. Pat. Nos. 3,218,776; 4,776,455; 6,727,215; 6,878,679; 7,259,134; 7,282,472; 7,304,025; 7,329,441; 7,439,215; 7,464,519; 7,595,290; and 8,551,929; the disclosures of all of which are incorporated herein by reference in their entireties. In preferred embodiments, the container is a water-soluble, single-chamber container, prepared from a water-soluble film. According to one such aspect of the invention, the single-chamber container is a formed, sealed pouch produced from a water-soluble polymer or film such as polyvinylalcohol (PVOH) or a PVOH film.

The water soluble container used in the compositions of the present invention is made from a water-soluble material which dissolves, ruptures, disperses, or disintegrates upon contact with water, releasing thereby the composition or cleaning system contained within the container. In one embodiment, the single-chamber or -compartment sealed water soluble container, which may be in the form of a pouch, is formed from a water soluble polymer. Non-limiting examples of suitable water soluble polymers include polyvinyl alcohol, cellulose ethers, polyethylene oxide, starch, polyvinylpyrrolidone, polyacrylamide, polyacrylonitrile, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resins, polyethyleneimine, ethyl hydroxyethylcellulose, ethyl methylcellulose, hydroxyethyl methylcellulose, and mixtures thereof. In one embodiment, the water soluble container is made from a lower molecular weight water-soluble polyvinyl alcohol film-forming resin.

Examples of water soluble polymers for forming the pouch are polyvinyl alcohol (PVOH) resins sold under tradename MonoSol® (MonoSol LLC, Indiana). One embodiment has a grade that is MonoSol® film having a weight average molecular weight range of about 55,000 to 65,000 and a number average molecular weight range of about 27,000 to 33,000. In some embodiments, the film material will have a thickness of approximately 3 mil or 75 micrometers. Alternatively, commercial grade PVOH films are suitable for use in the present invention, such as those that are commercially available from Monosol (Merrillville, Ind.) (e.g., Monosol film M8630) or from Aicello (Aiichi, Japan; North American subsidiary in North Vancouver, BC, Canada) (e.g., Aicello fil PT75).

In some embodiments, the water soluble container further comprises a cross-linking agent. In some embodiments, the cross-linking agent is selected from the group consisting of formaldehyde, polyesters, epoxides, isocyanates, vinyl esters, urethanes, polyimides, acrylics with hydroxyl, carboxylic, isocyanate or activated ester groups, bis(methacryloxypropyl)tetramethylsiloxane (styrenes, methylmetacrylates), n-diazopyruvates, phenylboronic acids, cis-platin, divinylbenzene (styrenes, double bonds), polyamides, dialdehydes, triallyl cyanurates, N-(2-ethanesulfonylethyl)pyridinium halides, tetraalkyltitanates, titanates, borates, zirconates, or mixtures thereof. In one embodiment, the cross-linking agent is boric acid or sodium borate.

In additional embodiments, the water-soluble container or film from which it is made can contain one or more additional components, agents or features, such as one or more perfumes or fragrances, one or more enzymes, one or more surfactants, one or more rinse agents, one or more dyes, one or more functional or aesthetic particles, and the like. Such components, agents or features can be incorporate into or on the film when it is manufactured, or are conveniently introduced onto the film during the process of manufacturing the cleaning compositions of the present invention, using methods that are known in the film-producing arts.

In some embodiments, the water soluble container comprises a protective layer between the film polymer and the composition in the pouch. In some embodiments, the protective layer comprises polytetrafluoroethylene (PTFE).

The single-compartment, water-soluble container (e.g., pouch) used in association with the present compositions may be in any desirable shape and size and may be prepared in any suitable way, such as via molding, casting, extruding or blowing, and is then filled using an automated filling process. Examples of processes for producing and filling water-soluble containers, suitable for use in accordance with the present invention, are described in U.S. Pat. Nos. 3,218,776; 3,453,779; 4,776,455; 5,699,653; 5,722,217; 6,037,319; 6,727,215; 6,878,679; 7,259,134; 7,282,472; 7,304,025; 7,329,441; 7,439,215; 7,464,519; and 7,595,290; the disclosures of all of which are incorporated herein by reference in their entireties. In some embodiments, the pouches are filled with the SCFT or ASCFT and/or the laundry detergent composition of the present disclosure using the cavity filling approach described in U.S. Pat. Nos. 3,218,776 and 4,776,455; machinery necessary for carrying out this process is commercially available, e.g., from Cloud Packaging Solutions (Des Plaines, Ill.; a division of Ryt-way Industries, LLC, Lakeville, Minn.).

### Methods of Use

The SCFTs and ASCFTs can be used to treat fabrics or textiles, e.g., to impart scent or soften or clean or decrease static build up when the treated textile is subsequently dried. The SCFTs and ASCFTs can be used for delivering fragrance or fabric care to a fabric or a textile, or cleaning a fabric or a textile, or combinations thereof by contacting the fabric or textile with a SCFT or ASCFT of the present disclosure.

In one embodiment is provided a method of treating a fabric or a textile comprising combining or contacting the fabric or textile to be treated, water, and a SCFT or ASCFT. The amount of SCFT or ASCFT can be, for example, about 0.001 g to about 1 kg per treatment. The amount of the SCFT or ASCFT can be, for example, about 0.01 g, about 0.1 g, about 1 g, about 2 g, about 3 g, about 4 g, about 5 g, about 6 g, about 7 g, about 8 g, about 9 g, about 10 g, about 25 g, about 50 g, about 100 g, about 200 g, about 300 g, about 400 g, about 500 g, about 600 g, about 700 g, about 800 g, or about 900 g per treatment.

In a further embodiment, is provided a method of cleaning or cleaning and treating a fabric or a textile with a unit dose SCFT or unit dose ASCFT of the present disclosure comprising combining or contacting the fabric or textile to be treated, water, and a unit dose SCFT or unit dose ASCFT of the present disclosure. The amount of the unit dose SCFT or unit dose ASCFT can be, for example, about 0.001 g to about 1 kg per treatment. The amount of unit dose ASCFT can be, for example, about 0.01 g, about 0.1 g, about 1 g, about 2 g, about 3 g, about 4 g, about 5 g, about 6 g, about 7 g, about 8 g, about 9 g, about 10 g, about 25 g, about 50 g, about 100 g, about 200 g, about 300 g, about 400 g, about 500 g, about 600 g, about 700 g, about 800 g, or about 900 g per treatment.

In a further embodiment is provided a method of cleaning or cleaning and treating a fabric or a textile with a unit dose laundry detergent composition of present disclosure comprising combining or contacting the fabric or textile to be treated, water, and the unit dose laundry detergent composition. The amount of the laundry detergent composition can be, for example, about 0.001 g to about 1 kg per treatment. The amount of laundry detergent composition can be, for example, about 0.01 g, about 0.1 g, about 1 g, about 2 g, about 3 g, about 4 g, about 5 g, about 6 g, about 7 g, about 8 g, about 9 g, about 10 g, about 25 g, about 50 g, about 100 g, about 200 g, about 300 g, about 400 g, about 500 g, about 600 g, about 700 g, about 800 g, or about 900 g per treatment.

The SCFTs, ASCFTs, laundry detergent compositions, and unit doses containing thereof can be used in a top loading or front loading washer, in hot, warm, or cold water. The SCFTs, ASCFTs, laundry detergent compositions, and unit doses containing thereof can be used with a detergent in a wash cycle, or separately but in conjunction with a detergent (e.g., in a separate wash or rinse cycle).

In one embodiment is provided a textile treated by a SCFT, an ASCFT, a unit dose, or a laundry detergent composition as disclosed herein.

The act of treating a textile can refer to, or example, one or more of: i) applying a perfume to a textile; ii) softening a textile; iii) applying a perfume to and softening a textile; iv) cleaning a textile; v) rendering the textile resistant to static build up during drying; or vi) cleaning a textile and applying a perfume to and softening a textile and rendering the textile resistant to static build up during drying; or any combination thereof.

The textile, after being treated, may be further processed, for example by drying, pressing, ironing, steaming, sewing, and the like.

The following examples are illustrative and do not limit the scope of the disclosure of the claims.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

All publications, patent applications, patents, and other references mentioned herein are incorporated by reference in their entirety. In case of conflict, the present specification, including definitions, will control. In addition, section headings, the materials, methods, and examples are illustrative only and not intended to be limiting.

### EXAMPLES

### Example 1: Formation of SCFTs in the Form of Pastilles

A block copolymer (PLURONIC F-68) was mixed with, optionally, a second block copolymer (PLURONIC F-38) and a glycol fatty acid ester (ethylene glycol monostearate) and the mixture was heated to about 145° F. until melted. A free fragrance (Azulete Neat Oil 495389) and/or an encapsulated fragrance (Popscent 259366 MHN 2925 with about 30% by weight water) were added to the molten mixture. Optionally, a colorant and/or a filler were added to the melted mixture. Mixing was effected, and the mixture was then dropped repeatedly onto a polymeric film to form drops. The drops were hardened to form pastilles, which were then removed from the polymeric film. Several SCFT formulations (Formulae 1-8) are presented in Table 2 below:

TABLE 2
SCFT Formulations

| | Formulas (% by weight) | | | | | | | |
|---|---|---|---|---|---|---|---|---|
| Ingredient | 1 | 2 | 3 | 4 | 5 | 6 | 7 | 8 |
| PLURONIC | 62.97 | 41.98 | 20.99 | 10.50 | — | — | — | — |
| F-38 | | | | | | | | |
| PLURONIC | 20.99 | 41.98 | 62.97 | 73.46 | 80.04 | 64.73 | 72.15 | 73.35 |
| F-68 | | | | | | | | |
| Ethylene | 6.03 | 6.03 | 6.03 | 6.03 | 8.17 | 11.61 | 6.77 | 12.43 |
| Glycol | | | | | | | | |
| Monostearate | | | | | | | | |
| (EGMS) | | | | | | | | |
| Azulete Neat | 5 | 5 | 5 | 5 | 5 | 5 | 5 | 5 |
| Oil 495389 | | | | | | | | |
| Fragrance | | | | | | | | |
| Encapsulated | 5 | 5 | 5 | 5 | 5 | 5 | 5 | 5 |
| Popscent | | | | | | | | |
| 259366 MHN | | | | | | | | |
| 2925 | | | | | | | | |
| Fragrance | | | | | | | | |
| (slurry with | | | | | | | | |
| about 30% by | | | | | | | | |
| weight water) | | | | | | | | |
| Colorant | 0.01 | 0.01 | 0.01 | 0.01 | 0.01 | 0.01 | 0.01 | 0.01 |
| Bentonite Clay | — | — | — | — | 1.78 | 13.65 | 11.07 | 4.21 |

Additional SCFT formulations (Formulae 9-14) are presented in Table 3 below:

TABLE 3
SCFT Formulations

| | Formulas (% by weight) | | | | | |
|---|---|---|---|---|---|---|
| Ingredient | 9 | 10 | 11 | 12 | 13 | 14 |
| PLURONIC F-38 | — | — | — | — | — | — |
| PLURONIC F-68 | 84.39 | 68.88 | 52.87 | 71.00 | 74.69 | 89.54 |
| Ethylene Glycol | 2.40 | 12.15 | 12.75 | 2.83 | 15.30 | 0.45 |
| Monostearate | | | | | | |
| (EGMS) | | | | | | |
| Azulete Neat Oil | 5 | 5 | 5 | 5 | 5 | 5 |
| 495389 Fragrance | | | | | | |
| Encapsulated | 5 | 5 | 5 | 5 | 5 | 5 |
| Popscent 259366 | | | | | | |
| MHN 2925 | | | | | | |
| Fragrance (slurry | | | | | | |
| with about 30% by | | | | | | |
| weight water) | | | | | | |
| Colorant | 0.01 | 0.01 | 0.01 | 0.01 | 0.01 | 0.01 |
| Bentonite Clay | 3.20 | 8.96 | 24.37 | 16.16 | — | — |

### Example 2: Formation of ASCFTs in the Form of Pastilles

A block copolymer (PLURONIC F-68) was mixed with a glycol fatty acid ester (ethylene glycol monostearate) and the mixture was heated to about 145° F. until melted. A free fragrance (Azulete Neat Oil 495389) and/or an encapsulated fragrance (Popscent 259366 MHN 2925 with about 30% by weight water) were added to the molten mixture. Optionally, a colorant and/or a filler were added to the melted mixture. The melted mixture was stirred using an overhead mixer with a 3-bladed propeller at 1500 rpm for 3 minutes. Air was incorporated into the melted mixture during the stirring. The mixture was then dropped repeatedly onto a polymeric film to form drops. The drops were hardened to form pastilles, which were then removed from the polymeric film. An example ASCFT formulation is presented in Table 4 below:

TABLE 4
ASCFT Formulation

| | Formula (% by weight) |
|---|---|
| Ingredient | 15 |
| PLURONIC F-68 | 89.54 |
| Ethylene Glycol | 0.45 |
| Monostearate (EGMS) | |
| Azulete Neat Oil 495389 | 5 |
| Fragrance | |
| Encapsulated Popscent | 5 |
| 259366 MHN 2925 | |
| Fragrance (slurry with | |
| about 30% by weight | |
| water) | |
| Colorant | 0.01 |
| Bentonite Clay | — |

### Example 3: Properties of SCFT and ASCFT Formulations

Physical properties of the SCFT and ASCFT formulations from Examples 1 and 2 (Formulae 1-15), were determined, including melting point, strength, and water solubility. The melting point for each formulation was determined using a melting point machine (MP50 by Mettler-Toledo®). The strength of each formulation was determined by measuring the force (Newtons) required to break the SCFT or ASCFT using a Dr. Schleuniger Pharmatron Model 6D Tablet Tester. Water solubility values were determined by measuring the amount of time (minutes) required for 0.28 grams of each formulation to completely solubilize using a stir-bar method at 59 □F in 500 mL of 120 ppm Ca²⁺/Mg²⁺ water in an 800 mL beaker, wherein the ratio of Ca²⁺:Mg²⁺ is 3:1. The stir-bar method utilized a 2′× 5/16′ (0002) stir bar by VWR® and a standard stir plate with agitation such that the vortex is about 1 inch from the stir bar. The properties for the SCFT and ASCFT formulations (Formulae 1-15) are summarized in Table 5 below:

TABLE 5
Properties of SCFT and ASCFT Formulations

| | Melting Point Range | | Water Solubility |
|---|---|---|---|
| Formula | (° C.) | Strength (N) | (minutes) |
| 1 | 43-51 | 9 | 6 |
| 2 | 46-56 | 10.2 | 7 |
| 3 | 46-58 | 11.4 | 8 |
| 4 | 44-61 | 13.8 | 11 |
| 5 | 44-60 | 10 | 15 |
| 6 | 47-60 | 10.66 | 16 |
| 7 | 43-59 | 10 | 15 |
| 8 | 44-61 | 14.33 | 15 |
| 9 | 39-56 | 11.33 | 19 |
| 10 | 39-61 | 8.33 | 15 |
| 11 | 36-61 | 9.66 | 18 |
| 12 | 42-61 | 8 | 14 |
| 13 | 46-61 | 15 | 18 |
| 14 | 43-51 | 10 | 12 |
| 15 | 43-51 | 10 | 7 |

### Example 4: Formation of ASCFTs Containing PEG in the Form of Pastilles

A polyethylene glycol 8000 (“PEG 8000”) is melted in a heated container equipped with a stirring apparatus, and mixed with a free fragrance (Azulete Neat Oil 495389), and/or an encapsulated fragrance (Popscent 259366 MHN 2925 with about 30% by weight water), and the mixture is heated to till melted with stirring, to create a homogenously mixed molten mixture. Air was incorporated into the melted mixture while the stirring. Optionally, a colorant and/or a filler are added to the melted mixture. The melted mixture is stirred using an overhead mixer with a 3-bladed propeller at 1500 rpm for 3 minutes. The mixture is then dropped repeatedly onto a polymeric film to form drops. The drops are hardened to form pastilles, which are then removed from the polymeric film. Three ASCFT formulations (Formulae 1-3) are presented in Table 6 below (QA means quality adjusted to make 100% by weight of the formula):

TABLE 6
ASCFTs Containing PEG

| | Formulas (% by weight) | | |
|---|---|---|---|
| Ingredient | 19 | 20 | 21 |
| PEG 8000 | 88 | 80 | 90 |
| Neat Oil Fragrance | 5 | 6 | 4 |
| Encapsulated Fragrance | 5 | 6 | 4 |
| Colorant | QA | QA | QA |
| Bentonite Clay | QA | QA | QA |

### Example 5: Preparation of Unit Dose Laundry Detergent Compositions

An exemplary unit dose laundry detergent composition is prepared by packaging 18 grams of a SCFT or ASCFT as described in Example 1 or 2, and 45 grams of a detergent formulation listed in Table 1, above, separately into two-chamber PVOH film pouches using a known method (e.g., the Cloud machinery). The SCFT or ASCFT formulation and the detergent formulation for an example unit dose laundry detergent composition are presented in the tables below:

| SCFT or ASCFT Ingredients | Ingredients % |
|---|---|
| PLURONIC F-38 | 62.97 |
| PLURONIC F-68 | 20.99 |
| EGMS | 6.03 |
| Azulete Neat Oil 495389 Fragrance | 5 |
| Encapsulated Popscent 259366 MHN | 5 |
| 2925 Fragrance (slurry with about | |
| 30% by weight water) | |
| Colorant | 0.01 |
| Bentonite Clay | — |

| Detergent Formulation Ingredients | Ingredients % |
|---|---|
| C₁₂-C₁₅ alcohol ethoxylate 7EO | 20.0000 |
| hexylene glycol | 29.0364 |
| glycerin | 5.0000 |
| monoethanolamine | 1.7000 |
| deionized water | 6.1200 |
| sodium sulfite | 0.1000 |
| linear alkyl benzene sulfonic acid | 5.0000 |
| (LAS) | |
| coconut oil fatty acid | 5.0000 |
| sodium lauryl ether sulphate 2 EO | 21.4286 |
| Soil-releasing polymer | 2.5000 |
| ALCOSPERSE ® 747 | 0.0000 |
| ACUSOL ® 445N | 0.0000 |
| DEQUEST SPE 1202 | 0.0000 |
| Enzymes | 2.8000 |
| Fragrance | 1.0000 |
| Dyes | 0.3150 |
| Total | 100.000 |

These unit dose laundry detergent compositions are suitable for delivery of fragrance to fabrics by including the unit dose laundry detergent compositions with the clothing in the wash chamber at the beginning of the wash cycle.

What is claimed is:

1. A solid composition for fabric treatment, comprising:
(a) a block copolymer having Formulae (I), (II), (III) or (IV),
R¹O-(EO)x-(PO)y-R² (I),
R¹O—(PO)x-(EO)y-R² (II),
R¹O-(EO)o-(PO)p-(EO)q-R² (III),
R¹O—(PO)o-(EO)p-(PO)q-R² (IV),
or a combination thereof;
wherein EO is a —CH₂CH₂O— group, and PO is a —CH(CH₃)CH₂O— group;
R¹ and R² independently is H or a C₁-C₂₂ alkyl group;
x, y, o, p, and q independently is 1-100;
provided that the sum of x and y is greater than 35, and the sum of o, p and q is greater than 35;
wherein the block copolymer has a molecular weight ranging from about 3000 g/mol to about 12,000 g/mol.
(b) a glycol fatty acid ester; and
(c) a fragrance,
wherein the solid composition is in a form comprising a pastille, a pellet, a powder, a pulverized powder, or a tablet.

2. The solid composition of claim 1, wherein the block copolymer is present in an amount of about 75 wt % to about 99 wt % of the composition.
The solid composition of claim 1, wherein the glycol fatty acid ester is present in an amount of from about 0.05 wt % to about 20 wt %.

3. The solid composition of claim 1, wherein the composition is substantially free of polyethylene glycol.

4. The solid composition of claim 1, wherein the block copolymer has Formula (I) or (II), or a combination thereof, and wherein the ratio of x:y ranges from about 1.5:1 to about 10:1.

5. The solid composition of claim 1, wherein the block copolymer has Formula (III) or (IV), or a combination thereof, and wherein the ratio of (o+q):p ranges from about 1.5:1 to about 10:1.

6. The solid composition of claim 1, wherein the block copolymer has a molecular weight ranging from about 3000 g/mol to about 12,000 g/mol.

7. The solid composition of claim 7, wherein the block copolymer comprising a mixture of two different block copolymers of Formula (III), wherein the two block copolymer each have a molecular weight ranging from about 4000 g/mol to about 9000 g/mol.

8. The solid composition of claim 8, wherein one of the block copolymer has a molecular weight ranging from about 4000 g/mol to about 5000 g/mol, and the other block copolymer has a molecular weight ranging from about 8000 g/mol to about 9000 g/mol, and
wherein the ratio of the block copolymer having a molecular weight ranging from about 4000 g/mol to about 5000 g/mol to the block copolymer having a molecular weight ranging from about 8000 g/mol to about 9000 g/mol ranges from about 1:3 to about 1:12.

9. The solid composition of claim 1, wherein the block copolymer has a hydrophilic-lipophilic-balance (HLB) ranging from about 15 to about 35.

10. The solid composition of claim 1, wherein the glycol fatty acid ester comprises a fatty acid portion having a carbon chain length of about 10 carbons to about 22 carbons.

11. The solid composition of claim 11, wherein the glycol fatty acid ester is a glycol monostearate or a glycol distearate.

12. The solid composition of claim 1, wherein the solid composition has a melting point ranging from about 32 □C to about 80 □C.

13. The solid composition of claim 1, wherein the solid composition has a strength from about 5 Newtons to about 50 Newtons.

14. The solid composition of claim 1 further comprising an sufficient amount of entrapped air or gaseous material.

15. The solid composition of claim 15, wherein the sufficient amount of entrapped air or gaseous material is the amount that makes the composition saturated with the air or gaseous material when the composition is in the liquid or melt stage.

16. The solid composition of claim 15, wherein the gaseous material comprises nitrogen, argon, helium, carbon dioxide, in combinations thereof, or in combination of air.

17. The solid composition of claim 15, wherein the solid composition which have been aerated has a density of at about 15% less than that of a reference composition without entrapped air.

18. The solid composition of claim 15, wherein the water solubility of the solid composition is increased by at least about 35% as compared to a reference composition without entrapped air, as measured by a stir-bar method at 59 □F in 120 ppm Ca²⁺/Mg²⁺ water, wherein the ratio of Ca²⁺:Mg²⁺ is about 3:1.

19. A method of making a solid composition for fabric treatment, comprising:
mixing and melting the block copolymer, the glycol fatty acid ester, and the fragrance according to claim 1 to form a mixture;
aerating the molten mixture to incorporate a sufficient amount of air or gaseous material into the mixture;
allowing the mixture to shape; and
hardening the shaped mixture.
